(19) United States
(12) Patent Application Publication
(10) Pub. No.: US 2026/0062235 A1
(43) Pub. Date: Mar. 5, 2026

(54) UNIT AND METHOD FOR TRANSFERRING ARTICLES

(71) Applicant: R.A JONES & CO.

(72) Inventors: Andrea BIONDI, Bologna (IT); Luca CAVAZZA, Bologna (IT); Antonio GIGANTE, Bologna (IT)

(73) Assignee: R.A JONES & CO., (US)

(21) Appl. No.: 19/102,373

(22) PCT Filed: Aug. 3, 2023
(86) PCT No.: PCT/IB2023/057844

§ 371 Date: Feb. 8, 2025

(30) Foreign Application Priority Data
Aug. 10, 2022 (IT) 102022000017118
Aug. 10, 2022 (IT) 102022000017121

(51) Int. Cl. B65G 47/96; B65G 47/53

(52) U.S. Cl. CPC B65G 47/96; B65G 47/53; B65G 2203/0291

(57) ABSTRACT

A transfer unit includes a first transfer element provided with a first support structure to receive an article, and a conveyor to receive the article from the first transfer element, positioned at a vertical height which is lower than the first support structure and movable along a transport direction. The first transfer element is moved by an actuation device between a receiving station in which the first transfer element receives the article and a storage station in which the first transfer element releases the article onto said conveyor. The transfer unit also includes a rotation unit to rotate the first support structure about a first rotation axis from a support configuration in which the article is supported by the first support structure to a discharge configuration in which the article is free to fall from the first transfer element onto the conveyor.

### CROSS REFERENCE TO RELATED APPLICATIONS

This application is a § 371 National Phase of PCT/IB2023/057844, filed Aug. 3, 2023, which claims priority of Italian Patent Applications Nos. 1020220000117118 and 102022000017121, filed Aug. 10, 2022, the entire contents of all of which are incorporated by reference herein as is fully set forth.

### FIELD OF THE INVENTION

The present invention relates to a unit and a method for transferring articles. The invention finds preferred use, even if not exclusive, in the transfer of articles into an apparatus for packaging articles in boxes, particularly suitable for packaging articles in accordance with a process in which the box is formed by folding a pre-formed blank. The invention also finds preferred, though not exclusive, application in the transfer of articles of variable geometry, such as bags containing loose material, or flowable material.

Therefore, reference will be made hereinafter to such a sector without thereby losing generality.

### BACKGROUND

In particular, in the relevant technical field, it is known to package articles inside a box according to a process which provides to prepare the articles to be packaged in a preparation unit and then transfer such articles to a packaging unit so that they can be packaged in boxes. The packaging in boxes can occur in a number of distinct modes. A first mode envisages a first step of forming a box, open at least at one end thereof, the subsequent insertion of the article to be packaged into the open box and, then, the closure of the open end. In a second mode, the box is formed by wrapping a blank around a mandrel which is made of a rigid material, e.g., metal, and which contains the article to be packaged.

In the present description as well as in the accompanying claims, some terms and expressions are deemed to assume, unless otherwise expressly indicated, the meaning expressed in the following definitions.

The term ‘article’ refers to any product which can be handled and moved by means of appropriate movement devices. Preferably, in the present description the term ‘article’ is intended as any product which can be packaged in boxes. The articles can have a predefined geometric shape, or they can have a variable geometry. Preferably, the articles are food and confectionery articles, either loose or contained inside bags or other types of wrapping. In particular, the term articles is used in the present description to refer to bags, or similar containers, made of flexible material enclosing therein loose, or flowing, material within the bag. For example, the articles can comprise bags of grains, individual chocolates (wrapped or unwrapped), candies, pouches containing solid, liquid or semi-solid food articles; also, articles from the tobacco industry, articles from the cosmetics industry, articles from the pharmaceutical industry, articles from the ‘personal & home care’ industry.

‘Flowing material’ or ‘loose material’ is intended as material in pieces such as flakes, granules, or powder, or gel. In some versions, the flowing material can also be formed by a single body of flexible material of variable geometry.

The term ‘transport direction’ is intended as the direction along which an object, e.g., an article, is transported. The transport direction is represented by an oriented line. When a direction, or a section thereof, are comprised within a plane, such a plane is defined as the ‘transport plane’ of the object.

With reference to a particular transport direction, a first element has an ‘advanced position’, or is defined as ‘advanced’, or is positioned ‘downstream’ with respect to a second element when along the oriented line identified by such a transport direction, the first element is located in a position subsequent to the position of the second element. Similarly, a ‘backward position’ or an ‘upstream’ position of a first element with respect to a second element is also defined when, along the oriented line identified by the direction, the first element is in an preceding position with respect to the position of the second element.

A vector quantity, e.g., speed, is defined by a ‘modulus’ and by a ‘direction’, intended herein to comprise also the direction, and can be represented by an oriented segment of length equal to the ‘modulus’ and oriented in the direction indicated by the ‘direction’.

A ‘support structure’ is a structure which allows to support an article, preventing the falling thereof. A support structure can consist of a single continuous element, or of a perforated element such as a grid, or even of a plurality of elements which are also continuous or perforated, e.g., comb-shaped. The support structure can also consist of a plurality of fixed elements or even a plurality of moving elements, such as a plurality of rollers or balls. The elements of the plurality of elements forming the support structure are shaped so that the spaces between two contiguous elements, or between two contiguous holes in the grid, are such as to prevent the passage of the article therethrough, so as to support the article.

In the context of the present description, the support structure is shaped so as to define a support plane having a planar or curved shape.

An article is ‘supported’ by a component of the transfer unit, when the component is in contact with the article and prevents the falling thereof. It should be specified that the support of the article does not in itself imply that the article is in contact over its entire surface with a component of the transfer unit, but it is sufficient that there is contact between the component and the article on one portion of the same article such as to prevent a fall of the article. It is sufficient that at least one portion of the component of the transfer unit is in contact with the article so as to support it.

An “abutment structure” can consist of a single continuous element, or of a perforated element such as a grid, or even of a plurality of elements which are also continuous or perforated, e.g., comb-shaped. The abutment structure can also consist of a plurality of fixed elements or even a plurality of moving elements, such as a plurality of rollers or balls. The elements of the plurality of elements forming the abutment structure are shaped so that the spaces between two contiguous elements, or between two contiguous holes in the grid, are such as to prevent the passage of the article therethrough.

In the context of the present description, the abutment structure is shaped so as to define an abutment plane having a planar or curved shape.

In particular, an article is ‘abutted’ by a component of the transfer unit when the component is in contact with the article and prevents the movement thereof in at least one direction. It should be specified that the abutment of the article does not in itself imply that the article is in contact over its entire surface with a component of the transfer unit, or conversely that an entire surface of the component of the transfer unit is in contact with the article, but it is sufficient that there is contact between the component and the article on a portion of the article itself and/or of the component of the transfer unit.

A ‘station’ indicates an operating position defined within a packaging process or in a packaging apparatus.

### SUMMARY

The Applicant first observed that a packaging process in which the article to be packaged is prepared in a preparation unit independent of the packaging unit and subsequently fed to the packaging unit allows to obtain significant advantages in terms of flexibility with respect to a packaging process in which the article to be packaged is prepared in the same packaging unit which is then intended to package the article in the box. Operating with the latter mode, it is in fact necessary to coordinate the article preparation operations with the packaging operations. Conversely, preparing the article in a separate preparation unit, it is possible to eliminate or limit the repercussions of any malfunctions in the preparation unit on the operation of the packaging unit, or vice versa.

The Applicant has noted that in such a packaging process, the articles are transferred at high speeds from the preparation unit to the packaging unit, due to the high production capacity required for packaging processes.

However, the Applicant has found that in such a transfer the articles may be damaged, in particular when the articles are formed by bags made of flexible material, and that in such a passage the products contained in the bags may also be damaged or break, especially if they have limited impact resistance.

In particular, the Applicant has observed that one of the critical steps in the transfer process, during which the articles can be most susceptible to damage, is the passage from the preparation unit to the packaging unit.

For this purpose, the Applicant has observed that the articles, after being possibly pre-assembled, are fed by means of a feed belt of the preparation unit to a conveyor of the packaging unit which is movable at a desired transport speed along a transport direction.

The Applicant noted that the feed belt is moved at high speeds to meet the high transport speeds required for the packaging process and that this implies that the articles are transferred at high speeds from the feed belt to the conveyor.

The Applicant has also noted that the feed belt is positioned perpendicular with respect to the conveyor to optimize space. Therefore, the feed direction of the feed belt is perpendicular to the transport direction of the conveyor.

The Applicant has also verified that the feed belt is positioned so that the outlet section thereof is at a higher vertical height with respect to the conveyor so as to improve the positioning of the articles on the conveyor.

The Applicant has therefore verified that in the passage from the feed belt to the conveyor, the articles are subject to an impact force having a tangential component, parallel to the conveyor transport speed and dependent on the conveyor transport speed, a longitudinal component, perpendicular to the conveyor transport speed and dependent on the movement speed of the feed belt and a vertical component dependent on the difference in height between the outlet section of the feed belt and the conveyor.

The Applicant has therefore verified that damage to the articles is more frequent and evident as the moduli of the impact force components involved and the fragility of the articles to be transferred increase.

The Applicant has therefore imagined using alternative transfer systems, e.g., reducing the movement speed of the feed belt so as to reduce the longitudinal component of the impact force of the article with the conveyor.

However, the Applicant has found that this possibility was limited by the need for a correct positioning of the article on the conveyor and above all by the high transport speed of the conveyor.

The Applicant therefore imagined using transfer systems having a limited vertical difference between the outlet section of the feed belt and the conveyor so as to reduce the vertical component of the impact force of the article on the conveyor.

However, the Applicant has found that such a possibility was limited by the need to achieve a homogeneous distribution of the flowable products inside the article, as well as by the need to obtain a correct positioning of the article on the conveyor.

The Applicant therefore imagined reducing the conveyor transport speed so as to reduce the tangential component of the impact force of the article and, therefore, the occurrence of tears and/or unwanted breakage.

However, the Applicant has verified that the possibility of using such transfer systems was limited by the productivity required for the packaging processes.

The Applicant therefore realized that in order to limit the possibility of damaging the articles and/or products contained therein during transfer, it was necessary to rethink the transfer unit.

The Applicant realized that it was necessary to reduce the impact force of the article on the conveyor. In particular, the Applicant realized that in order to avoid tears or damage to the article or the products contained therein, it was useful to reduce the relative speed between article and conveyor in the transport direction and/or in the longitudinal direction.

The Applicant therefore perceived that by using a movable transfer element along at least one section of the transport trajectory of the conveyor, and capable of moving along the same direction as the conveyor at a desired speed, and capable of releasing the article on the conveyor during this movement, the impact of the article with the conveyor would be advantageously reduced, thereby achieving a smooth and optimal impact of the article on the conveyor without thereby limiting the conveyor transport speed and, thus, the productivity of the packaging apparatus.

The Applicant finally found that a method and unit for transferring articles which provides to move a transfer to displace it for a section of the conveyor transport trajectory between a receiving station and a storage station along a chasing trajectory with a chasing speed having in the storage station a component with the same direction as the transport speed, surprisingly allows to optimize the positioning of the article on the conveyor and at the same time maintain high production speeds.

In other words, the Applicant has found that moving a transfer element between the receiving station and the storage station in a manner consistent with the conveyor allows to reduce the relative speed between the article and the conveyor in the transport direction and thus allows to reduce the tangential component of the impact force on the conveyor and to position the article correctly on the conveyor, while at the same time avoiding the defects discussed above.

Therefore, in a first aspect thereof, the invention relates to an article transfer unit.

Preferably, the transfer unit comprises a first transfer element provided with at least a first support structure intended to receive at least one of said articles.

Preferably, the transfer unit comprises, a conveyor adapted to receive said at least one article from said first transfer element, positioned at a lower vertical height with respect to said first support structure and movable along a transport direction at a transport speed.

Preferably, said first transfer element is movable between a receiving station in which said first transfer element is arranged to receive said at least one article and a storage station in which said first transfer element is arranged to release said at least one article on said conveyor.

Preferably, the transfer unit further comprises an actuation device configured to move said first transfer element between said receiving station and said storage station along a chasing trajectory with a chasing speed having in the storage station a component with the same direction as the transport speed.

Preferably, the transfer unit comprises a rotation unit configured to rotate said first support structure about a first rotation axis from a support configuration in which said at least one article is supported by said first support structure to a discharge configuration in which said at least one article is free to fall from said first transfer element onto said conveyor.

In a second aspect thereof, the invention relates to a method for transferring articles on a conveyor.

Preferably, the method comprises arranging a conveyor movable along a transport direction at a transport speed.

Preferably, the method comprises arranging at least a first transfer element of at least one of said articles provided with at least a first support structure intended to receive at least one of said articles and positioned at a higher vertical height with respect to said conveyor.

Preferably the method comprises positioning said first transfer element in a receiving station and feeding said article onto said first support structure so that said at least one article is supported by said first support structure.

Preferably, the method comprises moving said first transfer element from said receiving station to a storage station with a chasing speed having in the storage station a component with the same direction as the transport speed.

Preferably the method comprises rotating said first transfer element about a first rotation axis from a support configuration in which said at least one article is supported by said first support structure to a discharge configuration to make said article fall from said first transfer element onto said conveyor.

Preferably the method comprises transporting said article with said conveyor along said transport direction.

In a third aspect of the invention, an apparatus is provided for packing articles in boxes comprising a transfer unit according to the first aspect of the invention.

Preferably, the packaging apparatus comprises a preparation unit for preparing said at least one article and for feeding said at least one article to said transfer unit.

Preferably, the packaging apparatus comprises a packaging unit intended to receive said at least one article from said transfer unit and to package it in boxes.

Thanks to these features, the method and transfer unit according to the present technical solution allow an article to be efficiently positioned on a conveyor without damaging the article, moreover without penalizing production speed. Thanks to such features, it is also possible to precisely position the article on the conveyor.

By moving the first transfer element at a chasing speed having at least one chasing component with the same direction as the conveyor transport speed, the relative motion between the article and the conveyor in the transport direction is reduced and the tangential component of the impact force of the article on the conveyor can be limited or eliminated, thus allowing the article to be positioned on the conveyor more smoothly. Thanks to such a technical solution, the relative speed of the conveyor with respect to the first transfer element is lower than the absolute transport speed of the conveyor, thus reducing the tangential component of the impact force of the article on the conveyor. Furthermore, the position of the conveyor on which the article is deposited can be adjusted more precisely.

Such advantages are obtained without the need to reduce the conveyor speed and thus the productivity of the packaging unit.

The present invention, in at least one of the aforesaid aspects, may have at least one of the further preferred features set forth below.

In some versions, said first transfer element is positioned at a higher vertical height with respect to the conveyor and configured so that in said discharge configuration the projection of the first transfer element onto the conveyor is defined at an intended storage position of the at least one article on the conveyor. Thereby, at least one article can be discharged onto the conveyor with a force having essentially a vertical orientation. This allows to reduce or eliminate the longitudinal component of the impact force of the article with the conveyor. The Applicant has verified that this thereby achieves an optimal impact of the article on the conveyor without thereby limiting the productivity of the packaging apparatus.

In some versions, said chasing speed has a component in the storage station with the same direction as the transport speed and a modulus comprised between about ±40% of the transport speed modulus, preferably between about ±20% of the transport speed modulus, more preferably between about ±10% of the transport speed modulus.

In some versions, said chasing speed has a component in the storage station with the same direction as the transport speed and modulus essentially equal to the transport speed modulus. This thereby minimizes or eliminates the tangential component of the impact force of the article on the conveyor.

Preferably said chasing speed is parallel to the transport speed.

Preferably, said chasing speed has, in the storage station, a modulus comprised between about 2 m/sec and about 3 m/sec, preferably about 2.2 m/sec and 2.8 m/sec, most preferably about 2.4 m/sec.

Preferably said transport speed has a modulus comprised between about 2 m/sec and about 3 m/sec, preferably about 2.2 m/sec and 2.8 m/sec, most preferably about 2.4 m/sec.

Preferably, said first transfer element comprises a first abutment structure arranged transversally with respect to the first support structure, and cooperating with the first support structure in order to define, at least partially, a housing seat for said at least one article.

This thereby provides a transfer element adapted to more stably support said at least one article. The first support structure and the first abutment structure allow to limit unwanted movements or falls of at least one article from the first transfer element.

In some versions, said first abutment structure is provided in an advanced position in the chasing direction with respect to the first support structure. Such an expedient allows to make a transfer element which is particularly suitable for supporting lightweight articles or articles made of material with a low friction coefficient, which would therefore tend to move on the first support structure in the movement of the first transfer element.

In some versions, the first abutment structure is erected from the first support structure. The first abutment structure can be incident on the first support structure. This thereby further limits the possibility of the article accidentally falling from the transfer element.

Preferably, the first abutment structure extends from said first support structure in the opposite direction with respect to the conveyor.

In some versions, the first abutment structure is inclined by an angle comprised between 85° and 120° with respect to the first support structure, preferably about 90°.

In some versions, in the support configuration, said first support structure is extended along a substantially horizontal plane.

Preferably, the first abutment structure extends from said first support structure so as to define a housing seat open upwards. This allows to at least partially use the action of gravity to feed the article into the housing seat. In fact, it is possible to feed the article into the housing seat from above so that the positioning of the article in the housing seat and in particular on the support structure is eased by the action of the force of gravity. This facilitates the positioning of the article in the housing seat.

In some versions, in the support configuration, said first support structure is inclined by an angle comprised between ±30° with respect to a horizontal plane. The inclination of the first support structure is chosen based on the features of the article to be transferred. By varying the inclination of the first support structure, it is possible to adjust the rotation angle required for the article to fall onto the conveyor.

Preferably, the first support structure comprises a first proximal edge arranged towards or adjacent to the first abutment structure and a first free edge opposite the first proximal edge.

In some versions, in the support configuration, said first support structure is inclined so that said first proximal edge is positioned at a lower vertical height with respect to said first free edge. In other words, the first support structure is inclined with respect to a horizontal plane so as to move away from the conveyor plane away from the first abutment structure. Thereby, the article tends to position itself so as to be interposed between the first support structure and the first abutment structure and to be abutted by the first support structure and the first abutment structure. Therefore, the positioning of the at least one article on the first transfer element is improved.

Preferably said rotation unit is configured to rotate said first transfer element so that in said rotation from said support configuration to said discharge configuration said first abutment structure pushes said at least one article towards said conveyor.

Thereby, the at least one article is released from the transfer unit almost immediately and in any case before landing on the conveyor. After the article has been released from the transfer unit, it is possible to move the transfer unit back towards the receiving station. This thereby increases the efficiency of the transfer unit. Furthermore, by pushing the article onto the conveyor, it is possible to reduce the time required for the article to fall onto the conveyor.

Such an expedient also allows to improve the positioning of the at least one article on the conveyor. Such an effect is particularly noticeable in the case of articles of variable geometric shape, such as bags made of flexible material containing, for example, flowing material. Furthermore, if the bags contain flowing material, this improves the distribution of the flowing material inside the bag, easing a homogeneous distribution of the flowing material inside the bag. Pushing the article onto the conveyor by means of the first abutment structure eases the deposition on the conveyor of a regular-shaped bag, i.e., with minimal height differences in its extension, and thus easier to handle in the subsequent transformation operations. Furthermore, by reducing, or eliminating, the tangential and longitudinal components of the impact force on the conveyor, it is possible to impart a considerable push force to the article with the first transfer element without risking damage thereof. This implies that the article can be discharged in a very short time from the first transfer element. Furthermore, this results in an optimal positioning of the article on the conveyor.

In some embodiments, the rotation unit is configured to rotate said first transfer element so that, in said discharge configuration, said first abutment structure imposes a push on said at least one article with a force such as to accelerate the fall of the article. The modulus of the push force is appropriately calibrated, e.g., as a function of the type of article, so as to push the latter onto the conveyor without damaging it.

Preferably said rotation unit is configured to rotate said first transfer element between said support configuration and said discharge configuration by a rotation angle of ≥90°, preferably ≥120° preferably by a rotation angle of about 180°.

By increasing the rotation angle and/or the push force of the first abutment structure, e.g., by increasing the angular rotation speed of the first transfer element, the vertical component of the impact force of the article on the conveyor can be increased. This improves the positioning of the article on the conveyor and, above all, the distribution of the product flowing inside the bag. The Applicant has also found that by rotating the first transfer element with the above-mentioned rotation angles results in a good positioning of the product in the bag without damaging the product. The optimal working conditions are chosen based on the features of the article to be deposited and/or the product contained therein so as not to compromise the integrity of the bags and/or the flowable product contained therein.

Preferably said rotation unit is configured to rotate said first transfer element between said support configuration and said discharge configuration with a rotation speed comprised between about 50 rad/sec and about 80 rad/sec, preferably about 70 rad/sec. By varying the rotation speed of the first abutment structure, it is possible to vary the push of the article on the conveyor and to vary the vertical component of the impact force of the article on the conveyor. It is possible to improve the positioning of the article on the conveyor and, above all, the distribution of the product flowing inside the bag. The Applicant has also found that by adopting the above-mentioned rotation speed values, a good positioning of the product in the bag is obtained without damaging the product. The optimal working conditions are chosen based on the features of the article to be deposited and/or the product contained therein so as not to compromise the integrity of the bags and/or the flowable product contained therein.

Preferably said rotation unit is configured to rotate said first transfer element so that in said discharge configuration said first abutment structure faces said conveyor and is positioned vertically.

Preferably, said rotation unit is configured to rotate said first transfer element along a first rotation direction to move it from said support configuration to said discharge configuration and to rotate said first transfer element along a third rotation direction opposite the first rotation direction to bring it from said discharge configuration to said support configuration. It is thereby possible to rotate the transfer element to bring it back to the support configuration.

In some versions, an adjustment element is provided for adjusting at least one of the angular speed and the rotation angle of the first support element.

Preferably said rotation unit is configured to rotate said first transfer element from said support configuration to said discharge configuration in said storage station. The storage station is preferably provided at the storage position defined on the conveyor.

In some versions said conveyor is of the belt type defining a transport plane for said at least one article. The belt conveyor can be formed by a continuous belt or by a plurality of rollers rotating about respective rotation axes parallel to each other and jointly defining the transport plane for said at least one article.

Preferably said conveyor is positioned so as to define a horizontal transport plane, said transport direction being directed horizontally.

In some versions, said first rotation axis is a horizontal rotation axis.

Preferably said first rotation axis is parallel to the conveyor transport plane.

In some versions, said first rotation axis has a projection on the conveyor transport plane perpendicular to the transport direction.

In some versions, said first rotation axis has a projection on the conveyor transport plane parallel to the transport direction.

In some versions, said first rotation axis has a projection on the conveyor transport plane which is transverse with respect to the conveyor transport plane.

By suitably orienting the first rotation axis, it is possible to optimize the positioning of articles of various shapes and/or sizes on the conveyor.

In some versions, said actuation device is configured to move said first transfer element from said storage station to said receiving station along a return trajectory with a return speed having a return speed component with a direction opposite the transport speed.

Preferably the return speed is parallel to the transport speed and has the opposite direction to the transport speed.

Preferably said return speed has a greater modulus with respect to the chasing speed modulus. This allows to speed up the operation of the transfer unit.

Preferably said return speed has a modulus comprised between about 2.5 m/sec and about 3.5 m/sec, preferably between about 2.7 m/sec and about 3.2 m/sec, most preferably about 3 m/sec.

Preferably, said rotation unit is configured to rotate said first transfer element along said third rotation direction in the movement of said first transfer element from said storage station to said receiving station.

In some versions a plurality of separation elements is provided on the conveyor defining said storage position for said article on said conveyor.

Preferably, the separation elements of said plurality of separation elements project from the conveyor plane towards said first support structure of the transfer element.

In some versions, said conveyor is provided with a plurality of separation elements defining a plurality of storage positions on said conveyor, each intended to receive at least one article in said receiving station. The storage positions are suitably spaced on the conveyor along said transport direction.

In some versions, said transfer unit comprises a second transfer element.

In some versions said second transfer element is intended to cooperate with said first transfer element to support said at least one article.

In some versions, said second transfer element is intended to support at least a second article.

Preferably the second transfer element comprises a second support structure intended to support said at least one article, or at least a second article, of said plurality of articles.

In some versions, in the support configuration, said second support structure is extended along a substantially horizontal plane.

In some versions, in the support configuration, said second support structure is inclined by an angle comprised between +30° with respect to a horizontal plane.

In some versions, the first and/or second support structure is inclined with respect to the transport direction.

In some versions, the first and/or the second support structure is inclined with respect to the feed direction of the feed belt.

In some versions, the actuation device is mounted on said transfer unit and is configured to jointly move said first and said second transfer element. In some versions, the actuation device comprises a first actuation element mounted on said first transfer element and intended to move the first transfer element and a second transfer element mounted on said second transfer element and intended to move said second transfer element.

Preferably said rotation unit is configured to rotate said second support structure about a second rotation axis from a support configuration in which said at least one article or said at least a second article is supported by the second support structure to a discharge configuration in which said at least one article or said at least a second article is free to fall from said second transfer element onto said conveyor.

Preferably said rotation unit is configured to rotate said second support structure along a second rotation direction to bring it from said support configuration to said discharge configuration.

Preferably said rotation unit is configured to rotate said second support structure along a fourth rotation direction to bring it from said discharge configuration to said storage configuration.

In some versions said first transfer element and said second transfer element are positioned so that in said support configuration said first support structure and said second support structure are adjacent to each other.

Preferably, said first transfer element and said second transfer element are configured so that in said support configuration said first support structure and said second support structure are coplanar.

Preferably, said first transfer element and said second transfer element are configured so that in said support configuration said first support structure and said second support structure are spaced at a distance greater than zero, preferably comprised between 5 mm and 150 mm, more preferably comprised between 10 mm and 50 mm. A gap is therefore defined between the first transfer element and the second transfer element. The distance between the first support structure and the second support structure is chosen so as to facilitate the rotation of the first transfer element and the second transfer element while avoiding mutual interference and at the same time avoiding accidental falls of the article supported by the first transfer element and the second transfer element.

In some versions said second support structure is positioned so as to cooperate with said first support structure of said first transfer element so that said article is supported in said support configuration by said first support structure and by said second support structure. It is thereby possible to support the same article with the first transfer element and the second transfer element.

In some versions, said second transfer element comprises a second abutment structure arranged transversally with respect to the second support structure, and cooperating with the second support structure to define, at least partially, a housing seat for said at least one article.

In some versions, the second abutment structure is erected from the second support structure. The second support structure can be incident on the second support structure. This thereby limits the possibility of the article accidentally falling from the second transfer element.

Preferably, the second abutment structure extends from said second support structure in the opposite direction with respect to the conveyor.

In some versions, the second abutment structure is inclined by an angle comprised between 85° and 120° with respect to the second support structure, preferably about 90°.

Preferably, the second support structure comprises a second proximal edge arranged towards or adjacent to the second abutment structure and a second free edge opposite the second proximal edge.

In some versions, in the support configuration, said second support structure is inclined so that said second proximal edge is positioned at a lower vertical height with respect to said second free edge. Thereby, the article tends to position itself so that it is interposed between the second support structure and the second abutment structure and to be abutted by the second abutment structure and the second support structure, thus improving the positioning of the second article on the second transfer element.

Preferably, the second abutment structure extends from said second support structure so as to define a housing seat open upwards. This allows to at least partially use the action of gravity to feed the article into the housing seat. In fact, it is possible to feed the article into the housing seat from above so that the positioning of the article in the housing seat is eased by the action of the force of gravity. This facilitates the positioning of the article in the housing seat.

In some versions, said transfer unit comprises an adjustment device intended to adjust the distance between said first transfer element and said second transfer element. It is thereby possible to vary the distance between the first support structure and the second support structure. It is possible to vary the width of the seat defined by said first transfer element and said second transfer element. It is thus possible to transfer articles of different sizes from each other efficiently with the transfer unit.

In some versions, said first transfer element and said second transfer element are configured so as to jointly define a single housing seat for at least one article.

Preferably said first abutment structure and said second abutment structure are positioned on opposite sides with respect to each other so that said first support structure and said second support structure are interposed between said first abutment structure and said second abutment structure. In such a configuration, it is provided to rotate the first transfer element and the second transfer element in opposite directions from each other to bring them from the respective support configuration to the respective discharge configuration. Such a configuration allows to support the same article with the first transfer element and the second transfer element, or even to support two separate articles resting on the first support structure and the second support structure, respectively.

Preferably said second rotation axis is parallel to said first rotation axis.

In some versions, said second rotation direction is opposite said first rotation direction.

In some versions, said first abutment structure and said second abutment structure are positioned on the same side with respect to the first support structure or the second support structure, respectively. Thereby, only one of said first support structure or said second support structure is interposed between said first abutment structure and said second abutment structure. In such a version, said first rotation direction and said second rotation direction are concordant, and it is possible to rotate the first transfer element and the second transfer element in concordant directions to bring them from the support configuration to the discharge configuration.

Preferably, the first abutment structure is provided in an advanced position with respect to the first support structure along the transport direction.

Preferably, the second abutment structure is provided in an advanced position with respect to the second support structure along the transport direction.

Such a configuration allows to move the first transfer element and/or the second transfer element at high chasing speeds while avoiding accidental falls of the article they support.

In some versions, said rotation unit is configured to synchronously rotate said first support structure of said first transfer element and said second support structure of said second transfer element to bring them from the support configuration to the discharge configuration.

In some versions said rotation unit comprises a first rotation element intended to rotate said first transfer element and a second rotation element intended to rotate said second transfer element independently with respect to said first transfer element. It is thereby possible to rotate the first and the second transfer element independently from each other.

In some versions said rotation unit comprises a first rotation element mounted on said first transfer element and movable therewith and intended to rotate said first transfer element, and a second rotation element mounted on said second transfer element and movable therewith and intended to rotate said second transfer element.

In some versions, said first abutment structure comprises a first distal edge opposite the first support structure and a first edge proximal to the first support structure.

Preferably, the first transfer element comprises a first connecting portion extended from the first distal edge of the first abutment structure and diverging from the first abutment structure.

In some versions, said second abutment structure comprises a second distal edge opposite the second support structure and a second edge proximal to the second support structure.

Preferably, the second transfer element comprises a second connecting portion extended from the second distal edge of the second abutment structure and diverging from the second abutment structure.

The presence of the first connecting portion and/or the second connecting portion facilitates the insertion of the at least one article in the seat.

Preferably the first transfer element is ‘L’-shaped.

Preferably, the first transfer element is configured so as to define a single housing seat for at least one article.

Preferably, the first transfer element comprises a single support structure from which a single abutment structure is extended so as to define a single housing seat of the first transfer element. This allows to improve the positioning of at the least one article in the housing seat and above all to improve the positioning of the at least one article on the conveyor. The adjustment of the rotation of the first transfer element in the discharge configuration can be optimized.

Preferably, the second transfer element is ‘L’-shaped.

Preferably, the second transfer element is configured so as to define a single housing seat for at least one article.

Preferably, the second transfer element comprises a single support structure from which a single abutment structure is extended so as to define a single housing seat of the second transfer element. This allows to improve the positioning of at the least one article in the housing seat and above all to improve the positioning of the at least one article on the conveyor. The adjustment of the rotation of the first transfer element in the discharge configuration can be optimized.

Such a configuration allows to optimize the adjustment of the push of the article on the conveyor. The first and/or the second transfer element are configured so that no housing seat is defined for an article in the discharge configuration. In other words, it is necessary to rotate the first and/or the second transfer element to bring them into the receiving configuration so that another article can be loaded. Therefore, it is not necessary to adjust the rotation of the first and/or the second transfer element in the discharge configuration so as to define a new receiving position, and this allows the rotation angle and/or the rotation speed to be adjusted solely based on the features of the article to be deposited. In some versions, said first transfer element comprises a first blocking element which is inclined with respect to the first support structure and cooperating with said first support structure to prevent accidental falls of the at least one article from the first transfer element. The first blocking element is provided near a first longitudinal edge of the first support structure adjacent to the first proximal edge. The first blocking element is preferably extended from the first longitudinal edge of the first support structure.

In some versions said second transfer element comprises a second blocking element which is inclined with respect to the second support structure and cooperating with said second support structure to prevent accidental falls of the at least one article or the at least a second article from the second transfer element. The second blocking element is provided near a third longitudinal edge of the second support structure adjacent to the second proximal edge. The second blocking element is preferably extended from the third longitudinal edge of the second support structure.

In some versions, said first longitudinal edge and/or said third longitudinal edge are placed at a vertical height which is different from a vertical height of said second longitudinal edge and said fourth longitudinal edge, respectively.

In some versions said apparatus comprises a packaging unit intended to receive said at least one article from said conveyor and configured to package said at least one article in a box.

In some versions, said apparatus comprises a packaging unit intended to receive two articles from said conveyor and configured to package said articles in a single box.

Preferably said preparation unit comprises at least one belt feeder for feeding said at least one article to said transfer unit.

In some versions, said preparation unit comprises a pair of belt feeders intended to feed a first article to said first transfer element and a second article to said second transfer element of said transfer unit, respectively. The feeders of the pair of feeders can be spaced along the conveyor feed direction.

In some versions, said preparation unit comprises a filling hopper containing flowing material, and a bagging device for bagging said flowing material in at least one bag.

In some versions said transfer unit comprises a guide device for guiding said first transfer element and/or said second transfer element between said storage station and said receiving station.

In some versions, said method comprises moving said first transfer element from said receiving station to said storage station with a chasing speed having in the storage station a chasing component with the same direction as the transport speed and modulus comprised between about ±40% of the transport speed modulus, preferably comprised between about ±20%, more preferably comprised between about ±10% of the transport speed modulus.

In some versions said method comprises moving said first transfer element from said receiving station to said storage station with a chasing speed having in the storage station a chasing component with the same direction as the transport speed and modulus substantially equal to the transport speed modulus. Thereby in the storage station, the relative speed between the first transfer element and the conveyor is essentially zero.

Preferably in said storage station said first transfer element is in said discharge configuration.

In some versions said method comprises moving said second transfer element from said receiving station to said storage station with a chasing speed having in the storage station a chasing component with the same direction as the transport speed and modulus substantially equal to the transport speed modulus. Thereby in the storage station, the relative speed between the second transfer element and the conveyor is essentially zero.

Preferably in said storage station said second transfer element is in said discharge configuration.

In some versions, said method provides to push said at least one article from said first transfer element towards said conveyor in said discharge configuration. This thereby improves the positioning of the at least one article on the conveyor and the distribution of the flowable product within the bag, if present.

In some versions, said method comprises pushing said article in said discharge configuration from said first transfer element with a certain push force. This thereby imparts an acceleration greater than the acceleration of gravity on the article, pushing the article onto the conveyor. The value of the push force is chosen based on the features of the article being transferred. The Applicant has verified that by means of experimental tests it is possible to determine an appropriate push force which allows to obtain an optimal compromise between the integrity of the article and the correct positioning of the article on the conveyor and the flowable product in the bag.

Preferably said rotation comprises rotating said first transfer element by a rotation angle ≥90°, preferably ≥120°, preferably equal to 180° to move it between said support configuration and said discharge configuration.

Preferably said rotating comprises rotating said first transfer element between said support configuration and said discharge configuration with a rotation speed comprised between about 50 rad/sec and about 80 rad/sec, preferably about 70 rad/sec.

Preferably, said movement comprises moving said first transfer element with a chasing speed arranged parallel to said transport speed. It is thereby possible to chase said conveyor and release said article on said conveyor while minimizing the tangential component. This reduces the impact of the article on the conveyor, reducing the risk of damage to the article while ensuring a correct positioning of the article on the conveyor. In a preferred version, said chasing speed has a modulus essentially equal to the modulus of the transport speed.

Preferably said moving comprises positioning said first transfer element in said storage station in a position substantially corresponding to said predefined storage position defined on said conveyor. This thereby reduces, or limits, the longitudinal component of the impact force of the article on the conveyor.

Preferably said moving further comprises moving said first transfer element from said storage station to said receiving station, preferably with a return speed having a component opposite said transport speed. It is thereby possible to return said first transfer element in said receiving station to receive another article to transfer.

Preferably said return speed has a greater modulus with respect to said chasing speed.

Preferably, said depositing comprises depositing said article in at least one predefined position on said conveyor.

In some versions said method further comprises rotating said first transfer element in a third rotation direction which is opposite said first rotation direction to bring said first transfer element from said discharge configuration to said support configuration. This thereby returns the first transfer element to the support configuration in which it is arranged to receive and support an article.

In some versions, said rotation comprises rotating said first transfer element and said second transfer element in a synchronized manner to bring them from the support configuration to the discharge configuration. It is thereby possible to improve the storage of the article, or articles, supported by the first and the second transfer element. The working time of the packaging method is also optimized.

In some versions said rotating comprises rotating said first transfer element along a first rotation direction and rotating said second transfer element along a second rotation direction opposite the first rotation direction to bring them from the respective support configuration to the respective discharge configuration. This allows, for example, to load a single product on the first and on the second transfer element and deposit it on the conveyor thanks to the joint action of the first and the second transfer element. This allows, alternatively, to load two separate articles, one on the first transfer element and another on the second transfer element, and to deposit the two articles on the conveyor at the same time.

In some versions said rotating comprises rotating said first transfer element along a first rotation direction and said second transfer element along a second rotation direction concordant with the first rotation direction to bring them from the respective support configuration to the respective discharge configuration. This allows, for example, to load two separate articles respectively one on the first and one on the second transfer element and deposit them on the conveyor at the same time.

Preferably said method comprises simultaneously moving said first transfer element and said second transfer element from said receiving station to said storage station.

In some versions, said method comprises translating said transfer unit towards a first receiving station to feed a first article onto said first transfer element and further translating said transfer unit towards a second receiving station to further feed a second article onto said first transfer element. It is thereby possible to support two separate articles on the first transfer element, preferably overlapping each other.

In some versions, said method comprises translating said transfer unit towards a first receiving station to feed a first article onto said first transfer element and further translating said transfer unit towards a second receiving station to further feed a second article onto said second transfer element. It is thereby possible to support two separate articles, preferably side by side, one supported by the first transfer element and another supported by the second transfer element.

Preferably said method comprises further rotating said first transfer element about said first rotation axis along a third rotation direction opposite said first rotation direction to bring it from said discharge configuration to said support configuration.

Preferably said method comprises further rotating said second transfer element about said second rotation axis along a fourth rotation direction opposite said second rotation direction to bring it from said discharge configuration to said support configuration.

It is thereby possible to bring said first transfer element and/or said second transfer element into said support configuration, so that they are suitable for receiving another article.

Preferably said further rotating is provided during said further moving.

Preferably said rotating is provided during said moving.

Preferably said article comprises a bag containing loose material, e.g., flakes, or granular material.

Preferably said article comprises a bag containing grains.

It should be specified that some steps of the methods described above may be independent of the order of execution reported. In addition, some steps may be optional. In addition, some steps of the methods may be performed repetitively, or may be performed in series or in parallel with other steps of the method.

### BRIEF DESCRIPTION OF THE DRAWINGS

The features and advantages of the invention will become clearer from the detailed description of a preferred embodiment thereof, shown by way of non-limiting example, with reference to the appended drawings, wherein:

FIG. 1 is an interrupted schematic view of a transfer unit according to the invention and a feed unit;

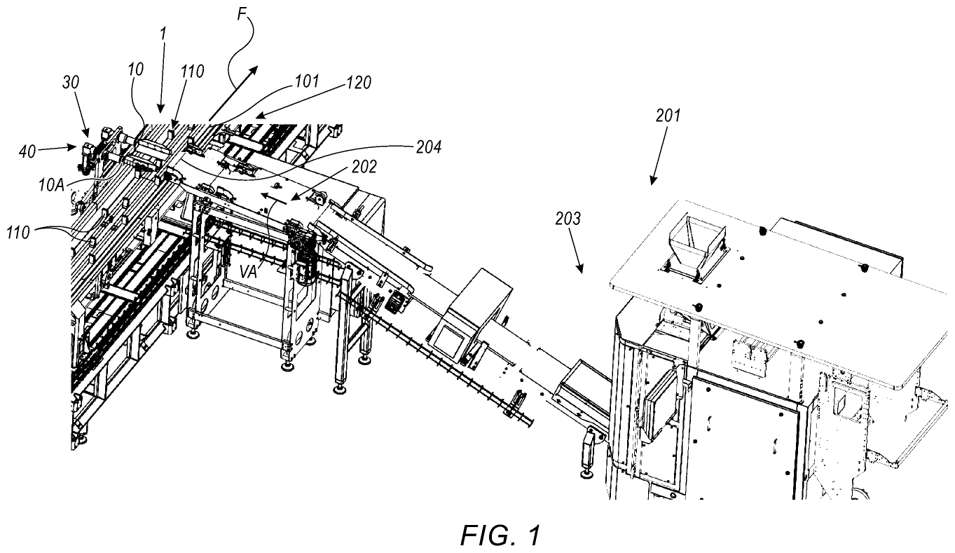

FIGS. 2 and 3 are two schematic views of a transfer unit in a first operating configuration without (FIG. 2) and with (FIG. 3) an article supported on the transfer unit, respectively;

FIG. 2A is an enlarged schematic view of the transfer unit of FIG. 2 with some parts removed for clarity;

FIG. 3A is an enlarged schematic view of the transfer unit of

FIG. 3 with some parts removed for clarity;

FIG. 3B is a view like that of FIG. 3A with the article removed for clarity;

FIG. 4 is a schematic view of a transfer unit in a second operating configuration;

FIG. 5 is a schematic view of a transfer unit in a third operating configuration;

FIG. 6 is a view like that of FIG. 5 in which an article deposited on the conveyor is shown.

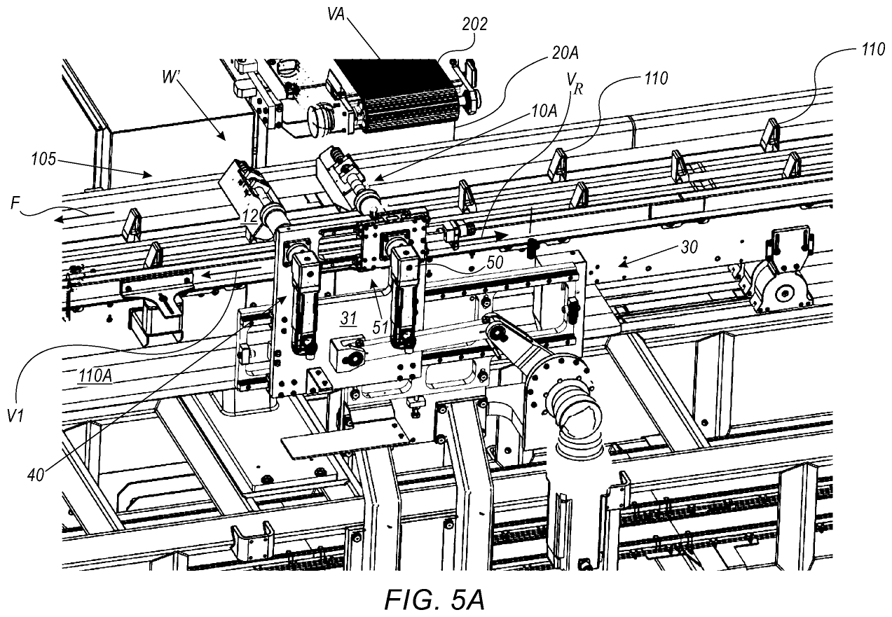

### DETAILED DESCRIPTION OF THE PREFERRED EMBODIMENTS

In the enclosed Figures, 1 globally refers to a transfer unit made in accordance with the present solution. The transfer unit 1 is configured to transfer articles 200 from a preparation unit 201 to a conveyor 101 of a packaging unit 120 which is intended to package the articles 200 in boxes. Such a packaging unit 120 is preferably of the ‘wrap-around’ type, obtaining the packaging by wrapping a box around an article 1 to be packaged.

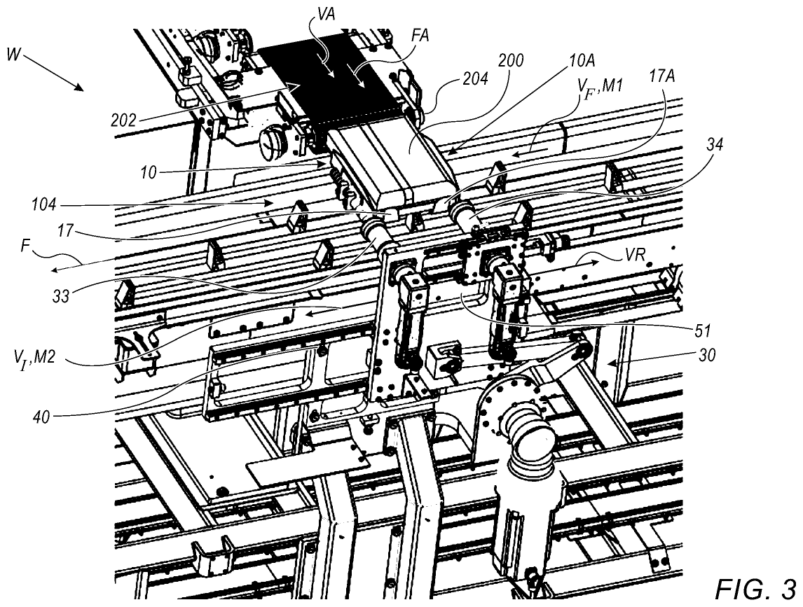

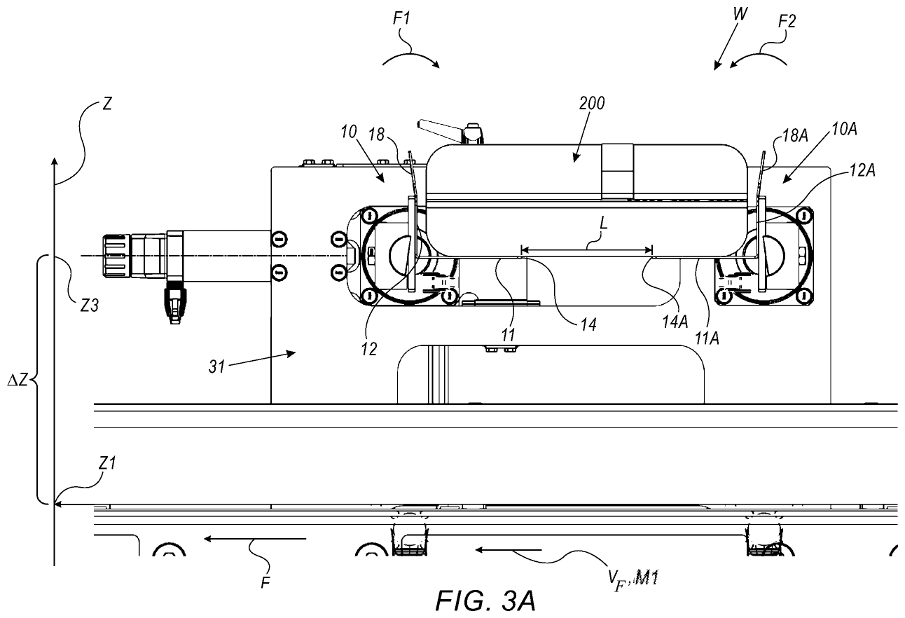

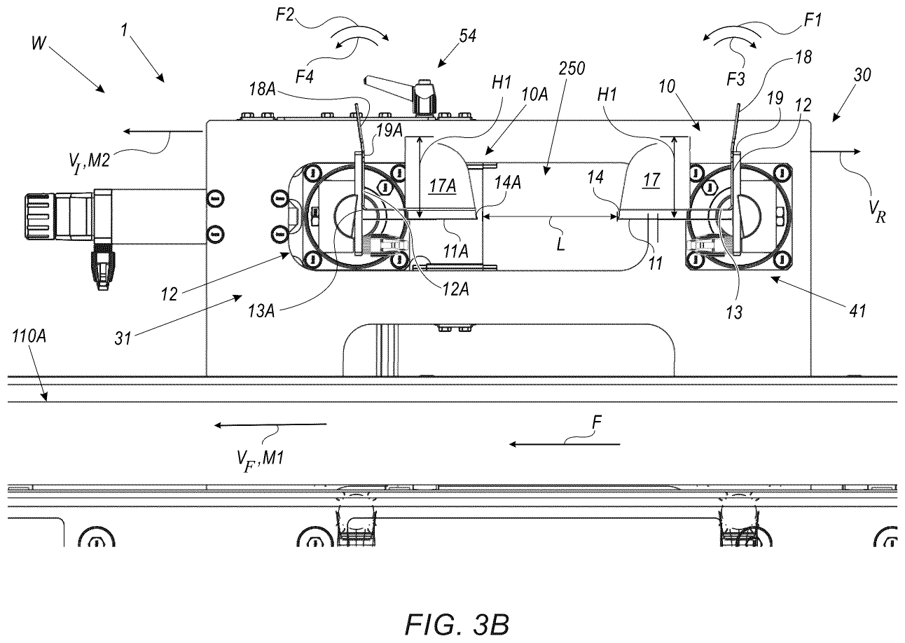

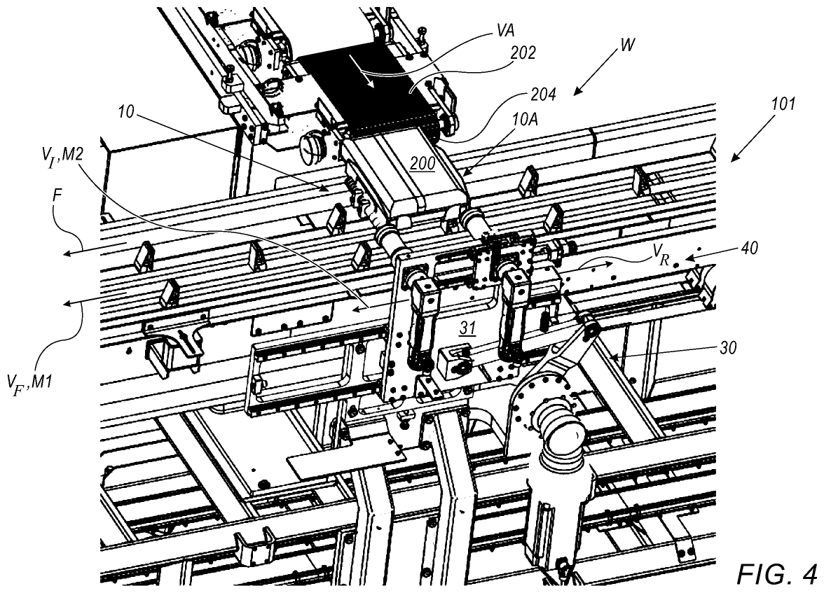

In the present example, the article 200 better visible in FIG. 3 or 4 consists of one or more flexible pouches, filled with predetermined quantities of flowable products in the form of a discrete particulate consisting of granules and/or flakes of grains and suitably sealed.

The preparation unit 201 comprises a filling and sealing plant 203 in which a flowable product is inserted in a pouch which is then sealed so as to form the article 200, and a feed belt 202 which receives the articles 200 from the filling and sealing plant 203 and moves them to an outlet section 204 of the feed belt 202 to feed the articles 200 to the transfer unit 1.

The feed belt 202 is arranged transversally with respect to the conveyor 101 and is movable along a feed direction Fa at a feeding speed Va.

The packaging unit 120 comprises the conveyor 101 which is formed by an endless belt arranged horizontally so as to define a horizontal transport plane and which transports the articles 200 along a transport direction F towards transformation devices provided downstream of the conveyor 101. The conveyor 101 is positioned at a lower vertical height Z1 with respect to the vertical height of the outlet section 204 of the feed belt 202. The conveyor 101 is driven at a transport speed VF having modulus M2. Preferably said transport speed VF has a modulus comprised between about 2 m/sec and about 3 m/sec, preferably about 2.2 m/sec and 2.8 m/sec, most preferably about 2.4 m/sec.

The conveyor 101 is provided with a plurality of separation elements 110 which project from the plane of the conveyor 101 upwards and define a plurality of predefined storage positions for the articles 200 on the conveyor.

The transfer unit 1 comprises in its most general units a first transfer element 10 and a second transfer element 10A cooperating to support the article 200, as better seen in FIGS. 3 and 3A.

The first transfer element 10 comprises a first support structure 11 intended to receive at least one article 200, and a first abutment structure 12 extending from the first support structure 11 and arranged almost perpendicularly with respect to the first support structure 11. The first abutment structure 12 cooperates with the first support structure 11 to define, at least partially, a housing seat 250 for an article 200.

The first support structure 11 has the shape of a flat slab delimited by a first proximal edge 13 from which the first abutment structure 12 extends, a first free edge 14 opposite the first proximal edge 13, a first longitudinal edge 15 and a second longitudinal edge 16. The first longitudinal edge 15 and the second longitudinal edge 16 extend along the transport direction F, the second longitudinal edge 16 faces the outlet section 204 of the feed belt 202, while the first longitudinal edge 15 is provided on the opposite side with respect to the outlet section 204 of the feed belt 202. The first proximal edge 13 is in an advanced position along the transport direction F with respect to the first free edge 14.

The first abutment structure 12 is also in the shape of a flat slab and comprises a first proximal edge adjacent to the first support structure 11 a first distal edge 19 provided on the opposite side with respect to the first support structure 11. The first transfer element 10 further comprises a first connecting portion 18 arranged transversally with respect to the first abutment structure 12 and extending from the first distal edge 19 towards the outside of the first transfer element 10, i.e., on the opposite side with respect to the housing seat 250 so as to define a lead-in for the insertion of the article 200 in the first transfer element 10 and to ease the fall of the article 200 onto the first support structure 11.

The first support structure 11 and the first abutment structure 12 are configured so as to define a first transfer element 10 having an ‘L’ shape. The first transfer element 10 is configured so as to define a single housing seat 250.

The housing seat 250 is preferably open upwards so that an article can be fed into the first transfer element 10 at least partially using the action of the force of gravity.

The first connecting portion 18 is inclined at an angle comprised between 0° and 20° with respect to the first abutment portion 12.

The first transfer element 10 further comprises a first blocking element 17 extending from the first longitudinal edge 15 extending in a nearly vertical direction from the first support structure 11 and having a vertical extension H1 such as to allow to block the article 200. The blocking element 17 allows to avoid accidental falls of the article 200 from the first transfer element 10 when it is fed by the feed belt 202.

The second transfer element 10A is structurally similar to the first transfer element 10, therefore the corresponding parts will be indicated with corresponding numerical references and not described in detail.

The first abutment structure 12 and the second abutment structure 12A face each other and are arranged so that the first support structure 11 and the second support structure 11A are interposed therebetween.

The second transfer element 10A is arranged so that the second free edge 14A is in an advanced position along the transport direction F with respect to the second proximal edge 13A.

The transfer unit 1 further comprises, a bearing structure 31 on which the first transfer element 10 and the second transfer element 10A are mounted by means of a first arm 33 and a second arm 34, respectively, and which is slidingly fixed to a guide rail 110A and an actuation device 30 configured to move the first transfer element 10 and the second transfer element 10A along the guide rail 110A along the conveyor 101.

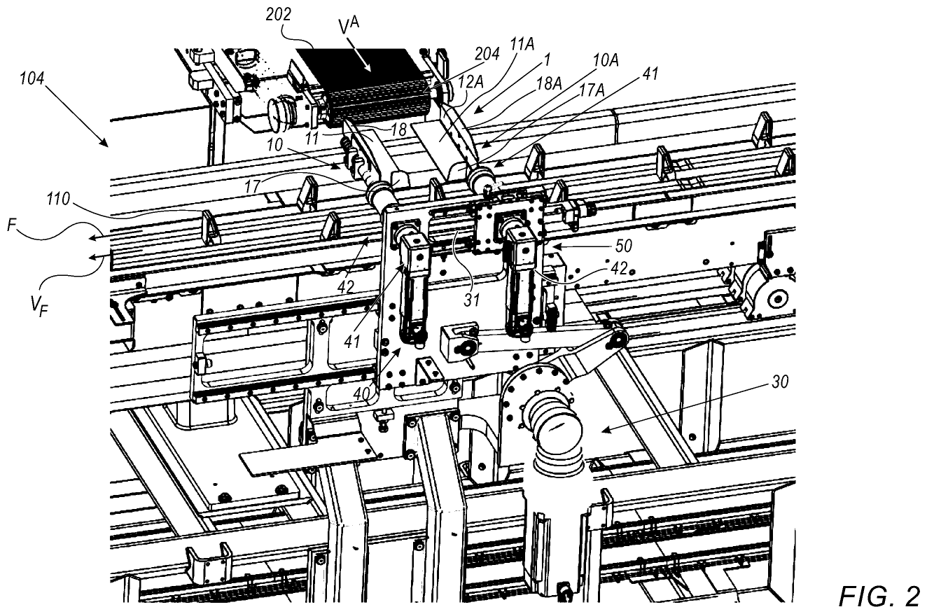

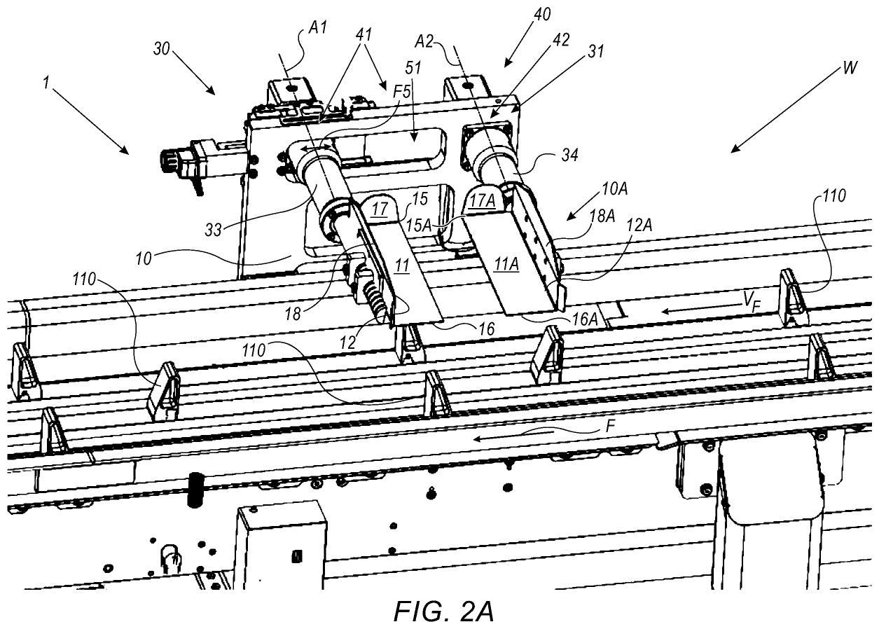

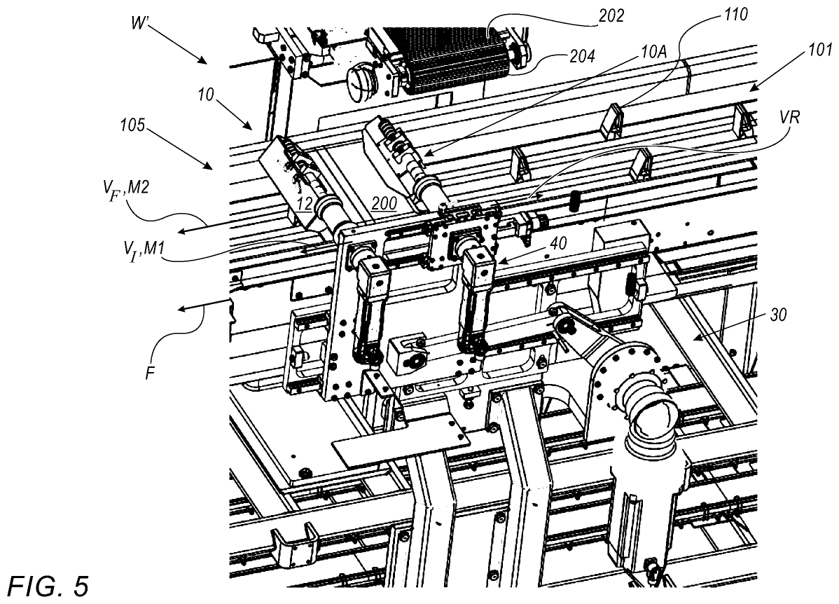

The actuation device 30 is mounted on the bearing structure 31. The actuation device 30 is configured to move the first transfer element 10 and the second transfer element 10A between a receiving station 104, shown in FIGS. 2 and 3, in which the first transfer element 10 and the second transfer element 10A are facing the feed belt 202 so as to receive an article 200 from the feed belt 202 and a storage station 105, shown in FIGS. 5 and 5A, in which the first transfer element 10 and the second transfer element 10A are arranged to release the article 200 onto the conveyor 101.

The receiving station 104 is provided at the outlet section 204 of the feed belt 202, the storage station 105 is provided in an advanced position with respect to the receiving station 104 along the transport direction F.

The actuation device 30 is provided with an actuation motor not visible in the figures, for moving the first transfer element 10 and the second transfer element 10A along a chasing trajectory with a chasing speed Vi with direction parallel to the transport speed VF and having in the storage station 105 modulus M1 roughly corresponding to modulus M2 of the transport speed VF.

Preferably, the actuation motor is arranged to move the first transfer element 10 and the second transfer element 10A with a chasing speed Vi having, in the storage station 105, a modulus comprised between about 2 m/sec and about 3 m/sec, preferably about 2.2 m/sec and 2.8 m/sec, most preferably about 2.4 m/sec.

The actuation device 30 is configured to move the first transfer element 10 and the second transfer element 10A from the storage station 105 to the receiving station 104 along a return trajectory with a return speed Vr parallel to the transport speed VF and having a direction opposite the transport speed VF.

Preferably the return speed Vr has a higher modulus with respect to the modulus of the chasing speed Vi, comprised between about 2.5 m/sec and about 3.5 m/sec, preferably between about 2.7 m/sec and about 3.2 m/sec, most preferably about 3 m/sec.

The transfer unit 1 further comprises a rotation unit 40 configured to rotate the first transfer element 10 about a first rotation axis A1 and the second transfer element 10A about a second rotation axis A2 to bring them from a support configuration W, shown in FIGS. 3 and 4, in which the article 200 is supported by the first support structure 11 and the second support structure 11A to a discharge configuration W′, shown in FIGS. 5 and 5A, in which the article 200 is free to fall from the first transfer element 10 and the second transfer element 10A onto the conveyor 101. The first rotation element 41 and the second rotation element 42 are mounted on the bearing structure 31.

In the support configuration W, the first support structure 11 and the second support structure 11A are arranged along a horizontal plane and are placed at the same vertical height Z3 above the vertical height Z1 of the conveyor 101, as shown in FIG. 3A. The difference between the vertical heights Z1 and Z3 is appropriately defined as a function of the dimensions of the first support structure 11 and the second support structure 11A and the separation elements 110 of the plane of the conveyor 101. In particular, it is suitable that in the discharge configuration W′ said first and second support structures 11, 11A are spaced apart by the separation elements 110 at least by a minimum amount, e.g., 10 mm.

The distance DZ between the first support structure 11 and the second support structure 11A and the conveyor 101 is such that the first transfer element 10 and the second transfer element 10A can rotate between the support configuration W and the discharge configuration W′ without hitting against the conveyor 101 or against the separation elements 110.

In some versions not shown in the Figures, in the support configuration W the first support structure 11 and the second support structure 11A are inclined with respect to a horizontal plane by an angle comprised between ±30°. The angle of inclination is chosen based on the features of the article so that it can be supported stably by the first and/or the second support structure.

The first rotation axis A1 is parallel to the second rotation axis A2. The first rotation axis A1 and the second rotation axis A2 are horizontal axes and are arranged so that their projection onto the conveyor 101 is perpendicular to the transport direction F.

The rotation unit 40 comprises a first rotation element 41 arranged to rotate the first transfer element 10 along a first rotation direction F1 and a second rotation element 42 arranged to rotate the second transfer element 10A along a second rotation direction F2 which is opposite the first rotation direction F1 to bring them from the support configuration W to the discharge configuration W′.

The rotation unit 40 comprises a rotation motor, not shown in the Figures, operatively connected to the first rotation element 41 and the second rotation element 42 so as to rotate the first transfer element 10 and the second transfer element 10A in a synchronized manner to release the article 200 onto the conveyor 101.

In other versions not shown, the rotation unit 40 rotates the first transfer element 10 and the second transfer element 10A independently of each other. The first rotation element 41 and the second rotation element 42 are mounted on the first transfer element 10 and the second transfer element 10A, respectively.

The rotation unit 40 is arranged to rotate the first transfer element 10 and the second transfer element 10A by an angle greater than 90°, e.g., 180°. Thereby, in the discharge configuration W′ the first support structure 11 and the second support structure 11A impose a push on the article 200 towards the conveyor 101.

In some embodiments, the rotation unit 40 is arranged to rotate the first transfer element 10 and the second transfer element 10A for an angle equal to 360°.

The rotation unit 40 is arranged to rotate the first transfer element 10 and the second transfer element 10A between said support configuration and said discharge configuration with a rotation speed comprised between about 50 rad/sec and about 80 rad/sec, preferably about 70 rad/sec.

In the support configuration W, the first support structure 11 and the second support structure 11A are adjacent to each other and coplanar and jointly define a support plane for the article 200. In the support configuration W, the first abutment structure 12 and the second abutment structure 12A face each other and are arranged on opposite sides with respect to the first support structure 11 and the second support structure 11A so that the latter are interposed between the first abutment structure 12 and the second abutment structure 12A. Furthermore, in the support configuration W, the first free edge 14 and the second free edge 14A are spaced by a distance L so as to ease the rotation of the first transfer element 10 and the second transfer element 10A.

The transfer unit 1 further comprises an adjustment device 50 intended to adjust the distance between the first transfer element 10 and the second transfer element 10A and in particular between the first proximal edge 13 and the second proximal edge 13A, thereby also determining the distance L between the first free edge 14 and the second free edge 14A. The adjustment device 50 comprises a slot 51 defined in the bearing structure 31 in which the first arm 33 of the first transfer element 10 is slidably housed.

The arm 33 can be moved in the slot 51 in either direction of the adjustment arrow F5 to vary the distance between the first free edge 13 and the second free edge 13A and thus vary the dimensions of the first housing seat 250 defined by the first transfer element 10 and by the second transfer element 10A. It is thereby possible to transfer articles 200 of different sizes with the transfer unit 1.

The adjustment device 50 further comprises a blocking element 54 for blocking the first transfer element 10 in the desired position with respect to the slot 51.

The rotation unit 40 is also arranged to rotate the first transfer element 10 along a third rotation direction F3 which is opposite the first rotation direction F1 and to rotate the second transfer element 10A along a fourth rotation direction F4 which is opposite the second rotation direction F2 to bring them from the discharge configuration W′ to the support configuration W.

The rotation unit 40 further comprises an adjustment device, not shown in the Figures, for adjusting at least one of rotation speed, rotation angle of the first transfer element 10 and/or the second transfer element 10A.

In operation, an article 200 is prepared in the filling and sealing plant 203, discharged onto the feed belt 202 and moved with a speed Va to the outlet section 204 of the feed belt 202.

By means of the actuation device 30, the transfer unit 1 is positioned at the outlet section 204 of the conveyor belt 202 so that the article in output from the conveyor belt 202 can be received in the seat 250.

Furthermore, the transfer unit 1 is positioned so that the support plane defined by the first support structure 11 and the second support structure 11A is positioned at a lower vertical height with respect to the outlet section 204 of the feed belt 202.

The article 200 is ejected from the feed belt at the speed Va to allow the article 200 to have a reach such that it falls onto the transfer unit 1 and be received in the seat 250 defined by the first transfer element 10 and by the second transfer element 10A. The first blocking element 17 and the second blocking element 17A provided in an opposite position to the outlet section 204 of the feed belt act as limit switch elements for the article 200, preventing the article 200 from falling out of the seat 250 when falling from the feed belt 202 at high speed.

In the fall towards the seat 250, the article 200 is guided by the first connecting portion 18 and/or the second connecting portion 18A.

In the transfer unit 1, the article 200 is positioned so as to be supported by the first support structure 11 and the second support structure 11A and abutted by the first abutment structure 12 and the second abutment structure 12A, as shown in FIGS. 3 and 3A.

In the receiving station 104, the transfer unit 1 is configured in the support configuration W in which the first support structure 11 and the second support structure 11A are coplanar and jointly define the support plane for the article 200.

Subsequently, the transfer unit 1 is moved by means of the actuation device 30 along the transport direction F with a chasing speed Vi parallel to the transport speed VF up to a discharge station 105 provided at a predefined storage position defined on the conveyor 101.

In the discharge station 105, the rotation unit 40 also rotates the first transfer element 10 and the second transfer element 10A to bring them into the discharge configuration W′.

In such a rotation, the first support structure 11 and the second support structure 11A are rotated so that the article 200 is no longer supported by them and can fall from the transfer unit 1.

In the rotation, the first abutment structure 12 and the second abutment structure 12A exert a certain push on the article 200 so as to push the article 200 towards the conveyor 101. The modulus of the push force in the discharge configuration W′ depends on the angular rotation speed of the first transfer element 10 and the second transfer element 10A, respectively, and the amplitude of the rotation angle. By rotating the transfer unit 1, the article 200 is released from the first support structure 11 and the second support structure 11A and pushed towards the conveyor 101 so that it falls towards the conveyor with an acceleration greater than the acceleration of gravity. As suitably mentioned, by adjusting the rotation angle and/or rotation speed of the transfer unit 1, it is possible to adjust the push of the article 200 on the conveyor 101.

In the discharge station 105, the first transfer element 10 and the second transfer element 10A move at approximately the same speed as the conveyor 101 so that the relative motion between the conveyor 101 and the first transfer element 10 and the second transfer element 10A along the transport direction F is approximately zero. Thereby, the article is subject to a substantially vertical force in falling onto the conveyor 101.

Furthermore, in the discharge station 105 the first transfer element 10 and the second transfer element 10A are in the discharge configuration W′ and the article is pushed towards the conveyor 101.

The provision of such a push together with the minimisation of the relative motion between conveyor 101 and first transfer element 10 and second transfer element 10A along the transport direction F allows to optimize the positioning of the article 200 on the conveyor 101. Furthermore, this thereby reduces the time required to deposit the article 200, and the transfer unit 1 can be moved from the release station 105 towards the receiving station 104 in an extremely short time.

After releasing the article 200, the first transfer element 10 and the second transfer element 10A are led by means of the actuation device 30 back towards the receiving station 104. In the movement from the discharge station 105 to the receiving station 104, the rotation unit 40 rotates the first transfer element 10 and the second transfer element 10A from the discharge configuration W′ back to the support configuration W, so that the transfer unit 1 is ready to receive a new article 200 in output from the feed belt 202.

In other versions not represented in the Figures, the transfer unit 1 can be used to support two articles.

In some versions, the transfer unit can be positioned in a first receiving station in which a first article is fed on one between the first transfer element and the second transfer element, subsequently moved to a second receiving station in which a second article is fed on the other between the first transfer element and the second transfer element. The first article and the second article can be fed by the same conveyor belt or by two separate conveyor belts. Next, the transfer unit provided with the first and the second article is moved towards the storage station in which the first article and the second article are deposited on the conveyor.

In some versions the transfer unit in the receiving station is provided to feed a first article and a second article onto the transfer unit. The first article and the second article can be positioned side by side one on the first transfer element and the other on the second transfer element.

In other versions, the first article and the second article can be overlapping each other, and both positioned on the first transfer element and on the second transfer element.

1. A transfer unit for transferring articles comprising:
a first transfer element provided with at least a first support structure intended to receive at least one of said articles, and
a conveyor adapted to receive said at least one article from said first transfer element, the conveyor being positioned at a vertical height lower than said first support structure and movable along a transport direction at a transport speed,
wherein said first transfer element is movable between a receiving station in which said first transfer element is arranged to receive said at least one article and a storage station in which said first transfer element is arranged to release said at least one article on said conveyor,
wherein said transfer unit further comprises, an actuation device configured to move said first transfer element between said receiving station and said storage station along a chasing trajectory with a chasing speed wherein said chasing speed in the storage station has a component with the same direction as the transport speed and
wherein said transfer unit further comprises a rotation unit configured to rotate said first support structure about a first rotation axis from a support configuration to a discharge configuration, wherein said at least one article in said support configuration is supported by the first support structure and wherein said at least one article in said discharge configuration is free to fall from said first transfer element onto said conveyor.

2. The unit according to claim 1, wherein said component of said chasing speed in the storage station has a modulus comprised between ±40% of the modulus of the transport speed.

3. The unit according to claim 1, wherein said first transfer element further comprises a first abutment structure arranged transversally with respect to the first support structure wherein said first abutment structure and said first support structure at least partially define a housing seat for said at least one article.

4. The unit according to claim 3, wherein said rotation unit is configured to rotate said first transfer element so that in said rotation from said support configuration to said discharge configuration said first abutment structure pushes said at least one article towards said conveyor.

5. The unit according to claim 1, wherein said rotation unit is configured to rotate said first transfer element between said support configuration and said discharge configuration by an angle of rotation ≥90°.

6. The unit according to claim 5, wherein said rotation unit is configured to rotate said first transfer element along a first rotation direction to move said first transfer element from said support configuration to said discharge configuration, and to rotate said first transfer element along a third rotation direction opposite said first rotation direction to bring said first transfer element from said discharge configuration to said support configuration.

7. The unit according to claim 1, wherein said chasing speed is parallel to the transport speed.

8. The unit according to claim 1, further comprising a second transfer element wherein said second transfer element has a second support structure cooperating with said first support structure of said first transfer element so that said article is supported in said support configuration by said first support structure and said second support structure.

9. The unit according to claim 8, wherein said rotation unit is configured to rotate said first transfer element about said first rotation axis along said first rotation direction and said second transfer element about a second rotation axis along a second rotation direction opposite to said first rotation direction to bring said first transfer element and said second transfer element from the support configuration to the discharge configuration, wherein said second rotation axis is parallel to said first rotation axis.

10. The unit according to claim 9, wherein said first transfer element and said second transfer element are positioned so that in said support configuration said first support structure and said second support structure are adjacent to each other.

11. A method for transferring articles onto a conveyor, the method comprising:
arranging a conveyor that is movable along a transport direction at a transport speed,
arranging at least a first transfer element for transferring at least one of said articles provided with at least a first support structure intended to receive at least one of said articles and positioned at a vertical height higher than said conveyor,
positioning said first transfer element in a receiving station and feeding said at least one article onto said first support structure so that said at least one article is supported by said first support structure,
moving said first transfer element from said receiving station to a storage station with a chasing speed, wherein said chasing speed in the storage station has a chasing component with the same direction as the transport speed,
rotating said first transfer element about a first rotation axis from a support configuration to a discharge configuration, wherein said at least one article in said support configuration is supported by the first support structure, to have said at least one article fall from said first transfer element onto said conveyor to deposit said at least one article on said conveyor, and
transporting said at least one article with said conveyor along said transport direction.

12. The method according to claim 11, wherein in said discharge configuration said at least one article is pushed from said first transfer element towards said conveyor.

13. The method according to claim 11, wherein said rotating comprises rotating said first transfer element by an angle of rotation ≥90° to move said first transfer element between said support configuration and said discharge configuration.

14. The method according to claim 11, wherein said chasing speed at the storage station has a chasing component with the same direction as the transport speed and a modulus between ±40% of the modulus of the transport speed.

15. The method according to claim 11, wherein said depositing comprises depositing said at least one article in at least one predefined storage position on said conveyor.

16. The method according to claim 11, further comprising rotating said first transfer element in the opposite direction with respect to said rotating from a support configuration to a discharge configuration, to bring said first transfer element from said discharge configuration to said support configuration.

17. The method according to claim 11, further comprising arranging a second transfer element intended to cooperate with said first transfer element to define said seat for said at least one article.

18. The unit according to claim 9, wherein said first transfer element and said second transfer element are positioned so that in said support configuration said first support structure and said second support structure are coplanar.

19. The method according to claim 11, wherein said moving comprises moving said first transfer element with a chasing speed having at the storage station a chasing component with the same direction as the transport speed and modulus corresponding to the modulus of the transport speed.
